(19) United States
(12) Patent Application Publication
(10) Pub. No.: US 2006/0231045 A1
(43) Pub. Date: Oct. 19, 2006

(54) Equine protective device

(76) Inventor: Carey Lindley, Driggs, ID (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/394,730

(22) Filed: Mar. 31, 2006

Related U.S. Application Data
(60) Provisional application No. 60/667,796, filed on Mar. 31, 2005.

(51) Int. Cl. A01K 27/00

(52) U.S. Cl. 119/856

(57) ABSTRACT

An equine protective device is disclosed. The equine protective device comprises a first housing removeably disposable around the lower portion of a horse's leg, wherein that first housing is formed to include a plurality of apertures extending therethrough. Applicant's invention further comprises a hoof liner removeably disposable around the horse's hoof, and a second housing removeably disposable around that hoof liner.

### CROSS-REFERENCE TO RELATED APPLICATIONS

This application claims priority from a U.S. Provisional Application having Ser. No. 60/667,796 filed Mar. 31, 2005.

### FIELD OF THE INVENTION

Applicant's invention relates to protective equipment for horses.

### BACKGROUND OF THE INVENTION

Prior art equine protective devices comprise materials that protect against cutting-type injuries, i.e. incisions and the like, but fail to distribute the force of a blunt impact, where that impact results from the horse's own hoof striking a leg, or from some other mechanical force, such as for example striking a fixed object such as a wood pole, or from the impact of a moving object such as a stone or rock. In addition, the prior art devices thermally insult the covered portion of the leg, and thereby, trap excessive heat against the horse's legs. This heat can cause tendon damage and other medical problems.

What is needed is an equine leg protection apparatus that protects the covered extremity from both laceration-type injuries, and also from blunt force-type injuries, wherein that protection apparatus is designed to admit ambient air as a cooling mechanism. Applicant's equine leg protector comprises a liner formed from impact-absorbing material, such as natural rubber or foam, in combination with an external housing comprising a molded resin, where that molded resin exhibits superior impact resistance, where both the liner and the housing are formed to include a plurality of apertures extending therethrough to allow air exchange and cooling.

### SUMMARY OF THE INVENTION

Applicant's invention comprises an equine protective device. Applicant's equine protective device comprises a first housing removeably disposable around the lower portion of a horse's leg, wherein that first housing is formed to include a plurality of apertures extending therethrough. Applicant's invention further comprises a hoof liner removeably disposable around the horse's hoof, and a second housing removeably disposable around that hoof liner.

### BRIEF DESCRIPTION OF THE DRAWINGS

The invention will be better understood from a reading of the following detailed description taken in conjunction with the drawings in which like reference designators are used to designate like elements, and in which:

FIG. 1A is a block diagram showing one embodiment of Applicant's equine protective device;

FIG. 1B is a block diagram showing a second embodiment of Applicant's equine protective device;

FIG. 2A is a perspective view of one embodiment of Applicant's equine leg housing portion;

FIG. 2B is a perspective view of a second embodiment of Applicant's equine leg housing portion;

FIG. 2C is a bottom view of Applicant's equine leg housing;

FIG. 3 is a perspective view showing Applicant's equine leg housing comprising a one-piece assembly comprising a first end and a second end;

FIG. 4 is a perspective view showing a plurality of first attachment means and second attachment means used to releaseably attach to first end of Applicant's equine leg housing to the second end of that housing;

FIG. 5A is a perspective view showing Applicant's equine leg liner;

FIG. 5B is a bottom view of the liner of FIG. 5A;

FIG. 6 is a perspective view showing one means to attach Applicant's leg housing to Applicant's boot housing;

FIG. 7 is a cross-sectional view of one embodiment of Applicant's leg liner used in combination with one embodiment of Applicant's leg housing;

FIG. 8A is a perspective view of Applicant's boot housing;

FIG. 8B is a perspective view showing Applicant's equine boot housing comprising a one-piece assembly comprising a first end and a second end;

FIG. 8C is a perspective view showing a plurality of first attachment means and second attachment means used to releaseably attach to first end of Applicant's boot housing to the second end of that housing;

FIG. 9 is a perspective view of Applicant's boot liner;

FIG. 10 is a bottom view of Applicant's equine leg housing showing that housing formed to include a plurality of apertures, wherein Applicant's liner comprises a plurality of rectangular liner portions, wherein each liner portion is attached to the interior of the equine leg housing between two apertures; and

FIG. 11 is a bottom view of Applicant's equine leg housing showing that housing formed to include a plurality of apertures, wherein Applicant's liner comprises a plurality of circular liner portions, wherein each liner portion is attached to the interior of the equine leg housing between two apertures.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

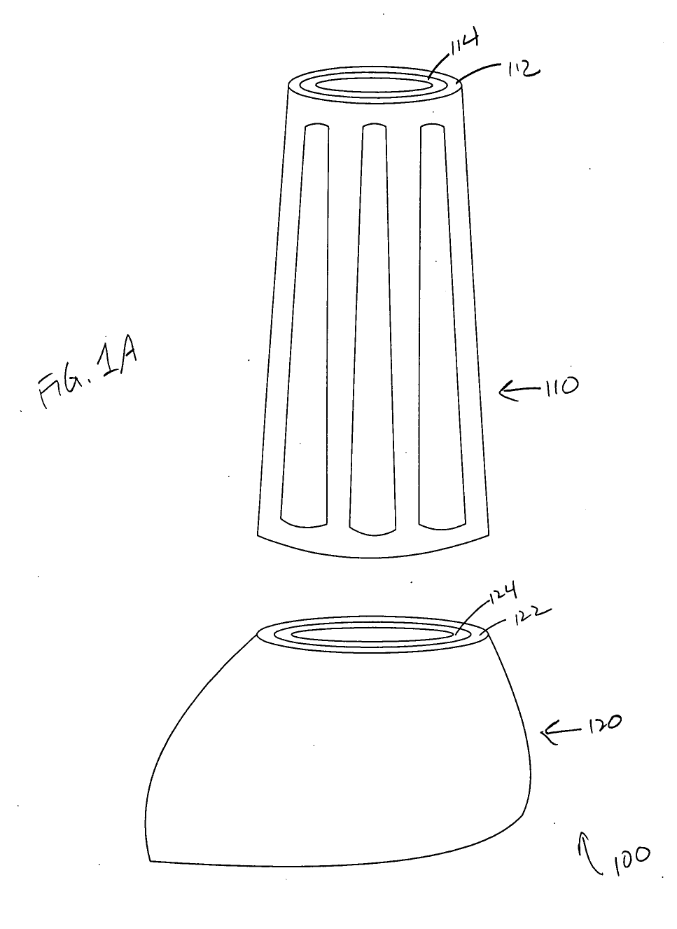

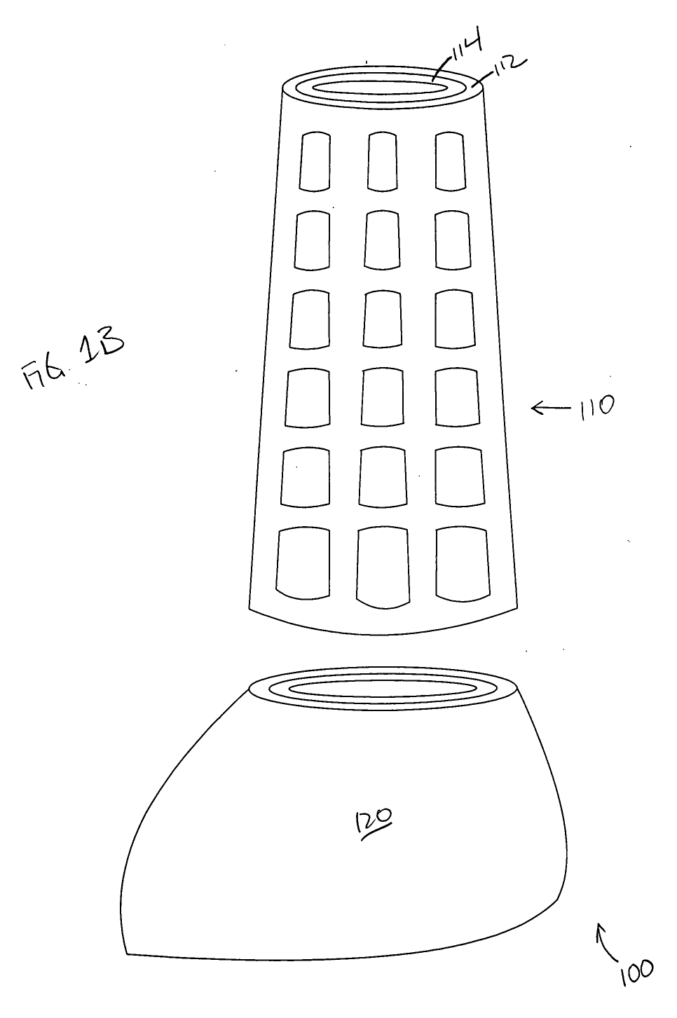

Equine protective device 100 (FIGS. 1A, 1B) comprises a splint for a horse's leg.

Referring to FIGS. 1A and 1B, equine protective apparatus 100 comprises what is sometimes called a bell boot or a splint boot. Apparatus 100 comprises leg assembly 110 and boot assembly 120. Leg assembly 110 comprises leg housing 112 and a leg liner 114, wherein leg liner 114 may comprise a unitary structure or may comprise a plurality of leg liner portions. Leg housing 112 is dimensioned to be removeably disposable around the lower portion of a horse's leg. By “lower portion of a horse's leg,” Applicant means that part of a horse's leg between the bottom of the fetlock and the knee. Boot assembly comprises housing 122 and liner 124.

For purposes of clarity, Applicant's Figures show leg housing 112 comprising a conical shape. In implementation, certain embodiments of Applicant's leg housing 112 comprise the configuration of a horse's lower leg, wherein that configuration is more complex than a conical shape.

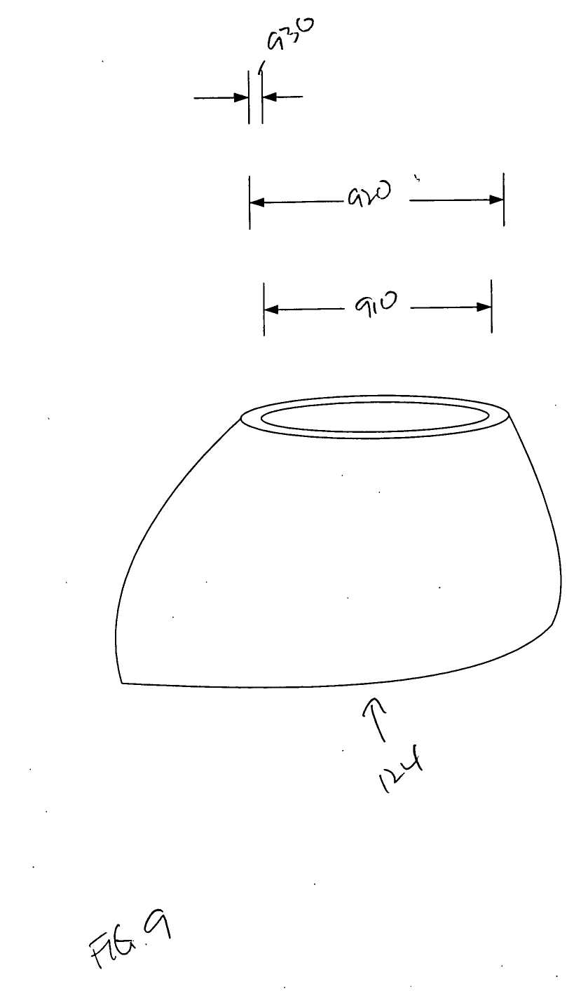

Referring now to FIG. 9, boot liner 124 is formed to define the shape of a horse hoof. Boot liner 124 is formed to include an opening at the top having a diameter 910. Diameter 910 is dimensioned such that a horse's leg can extend outwardly from boot liner 124 through aperture 910. Boot liner comprises thickness 930. In certain embodiments, thickness 930 is between about 0.10 inch and about 1 inch. In certain embodiments, liner 124 is about 0.25 inch thick.

In certain embodiments, liner 124 is formed from natural rubber. In other embodiments, Applicant's liner 124 is formed from a highly-resilient, flexible foam. In certain embodiments, liner 124 is formed from a flexible polyurethane foam. In certain embodiments, that flexible foam is formed using toluene diisocyanate. In other embodiments, that flexible foam is formed using methylene diisocyanate.

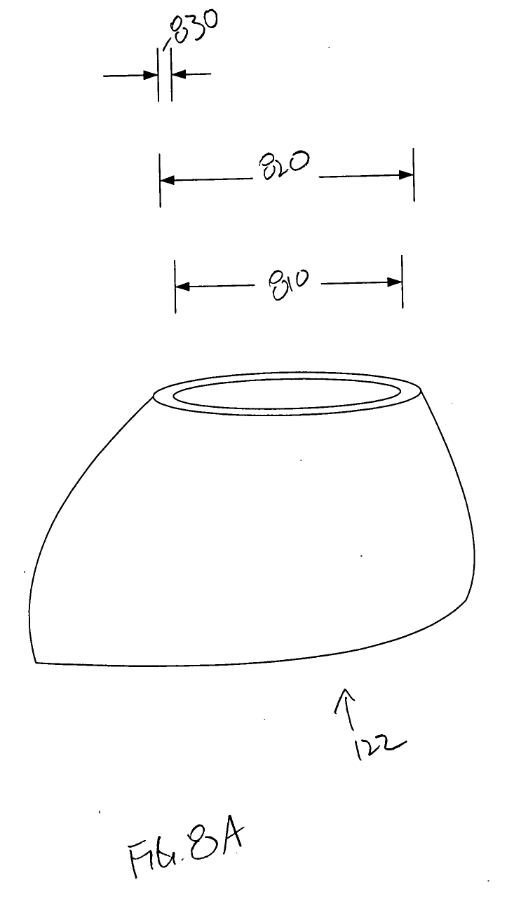

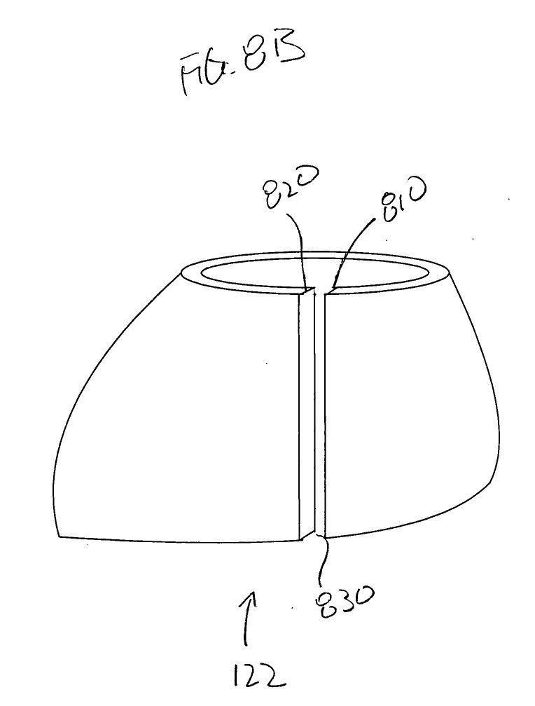

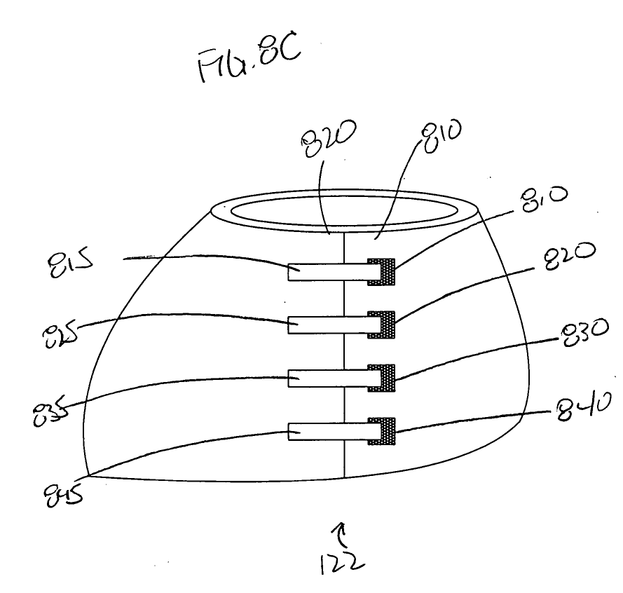

Referring now to FIG. 8A, boot housing 122 is formed to define the shape of a horse hoof. Boot housing 122 is formed to include an opening at the top having a diameter 810. Diameter 810 is dimensioned such that a horse's leg in combination with liner 124 can extend outwardly from boot housing 122 through aperture 810. Diameter 810 is greater than diameter 910 (FIG. 9).

Boot housing comprises thickness 830. In certain embodiments, thickness 830 is between about 0.10 inch and about 1 inch. In certain embodiments, housing 122 is about 0.25 inch thick.

In certain embodiments, boot housing 122 is formed from a rigid polymeric material, such as for example polycarbonate, polyethylene, polypropylene, combinations thereof, and the like. In other embodiments, housing 122 is formed from a rigid cellular material, such as a rigid polyurethane foam, a rigid polystyrene foam, a rigid polyethylene foam, combinations thereof, and the like.

In certain embodiments, boot liner 124 is attached to the inner surface of boot housing 122 using conventional attachment means, such as adhesive bonding, hook and loop fasteners, and the like.

Referring now to FIG. 8B, in certain embodiments Applicant's boot housing 122 comprises a one-piece assembly having a first end 810 and a second end 820. In order to dispose housing 122 around a horse's lower hoof, ends 810 and 820 are manually urged in different directions to open gap 830 sufficiently to place the expanded housing 122 around the hoof. Thereafter, ends 810 and 820 are urged inwardly to enclosed the target hoof.

Referring now to FIG. 8C, in certain embodiments housing 122 further comprises a plurality of first attachment means and second attachment means to releaseably secure the housing in the closed configuration shown in FIGS. 1A, 1B, 8A, and 8C. Referring now to FIG. 8C, in certain embodiments housing 122 comprises a plurality of first attachment means disposed along end 820, and a plurality of second attachment means disposed along end 810.

In the illustrated embodiment of FIG. 8C, housing 122 comprises a plurality of hook and loop fastener assemblies, such as hook and loop fastener assemblies 810/815, 820/825, 830/835, and 840/845. In the illustrated embodiment of FIG. 8C, flexible member 815 comprises a proximal end attached to end 820 of housing 122, a distal end extending outwardly from end 820, and a fastening means, such as fabric comprising a plurality of hook-type fasteners, disposed on the interior surface of that distal end such that the plurality of hook-type fasteners contact, and releaseably attach to, the fastener-receiving means 810 disposed on end 810 of housing 122. Hook and Loop fastener assemblies 820/825, 830/835, and 840/845, operate similarly. In other embodiments, fastener assemblies 810/815, 820/825, 830/835, and 840/845, comprise snaps disposed on the distal ends of flexible members 815, 825, 835, and 845, wherein those snaps are received by, and releaseably attach to, snap-receiving devices 810, 820, 830, and 840.

In other embodiments, boot housing 122 is formed in two halves, wherein those two halves can be placed on the horse's hoof, and then joined using a plurality of fastener means disposed on each of the two halves.

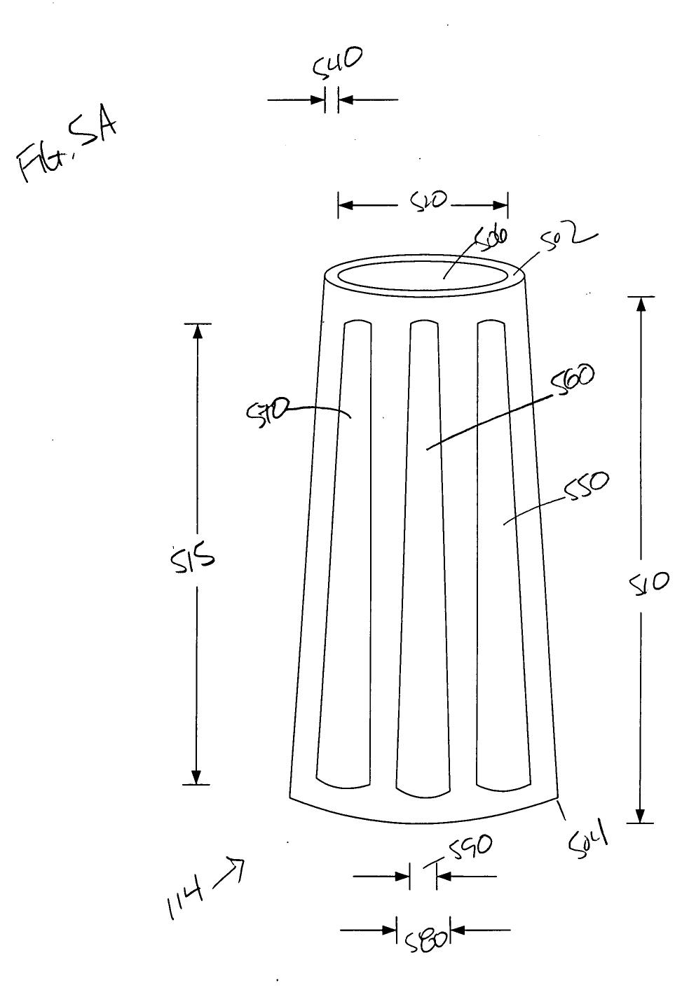

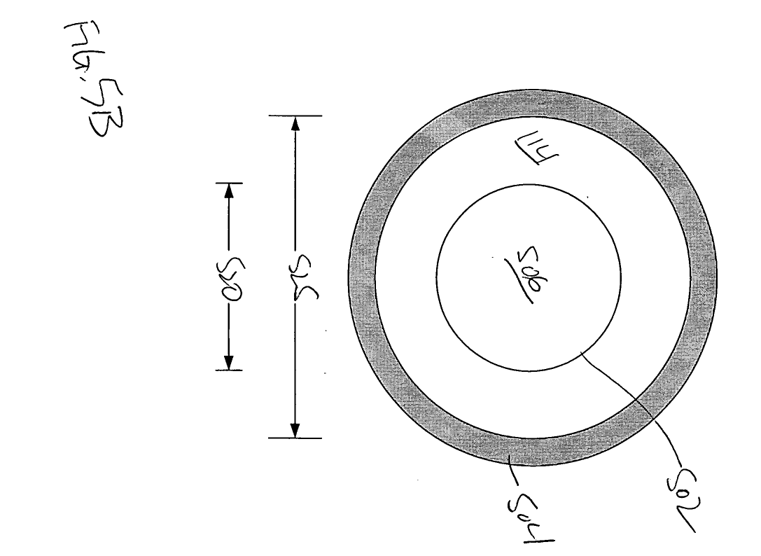

Referring now to FIG. 5A, liner 114 comprises a length 510. Length 510 is adjusted based upon the breed and size of the horse. As a general matter, length 510 is determined by measuring the distance between the horse's fetlock to one inch below the knee.

In the illustrated embodiment of FIGS. 5A and 5B, liner 114 comprises a tubular member comprising a first end 502, a second end 504, and a lumen 506 interconnecting the first end 502 and the second end 504, wherein lumen 506 comprises a first inner diameter 520 at first end 502 and a second inner diameter 525 at the second end 504.

In actual use, the dimensions of lumen 506 are substantially the same as the dimensions of the target lower leg. By “substantially the same,” Applicant means within about plus or minus 10 percent. Liner 114 is formed from an elastomeric materials that can be stretched such that liner 114 can be removeably disposed around the target lower equine leg.

In certain embodiments, liner 114 is formed from natural rubber. In other embodiments, Applicant's liner 114 is formed from a highly-resilient, flexible foam. In certain embodiments, liner 114 is formed from a flexible polyurethane foam. In certain embodiments, that flexible foam is formed using toluene diisocyanate. In other embodiments, that flexible foam is formed using methylene diisocyanate.

In certain embodiments, first inner diameter 520 is between about 2 inches and about 5 inches. In certain embodiments, the second inner diameter 525 is between about 2 inches and about 5 inches.

Liner 114 further comprises thickness 540. In certain embodiments, thickness 540 is between about 0.10 inch and about 1 inch. In certain embodiments, liner 114 is about 0.25 inch thick.

In the illustrated embodiment of FIG. 5A, liner 114 is formed to include a plurality of slit-like apertures, such as apertures 550, 560, and 570. Apertures 550, 560, and 570, allow air flow to assist in maintaining a normal body temperature in the covered leg. In the illustrated embodiment of FIG. 5, apertures 550, 560, and 570, comprise an aperture length 515, and a varying width in the range defined by the first aperture width 590 and the second aperture width 580.

In certain embodiments, aperture length 515 is 1 inch less than housing length 510. In certain embodiments, first aperture width 590 is between about ⅛ inches and about ½ inch. In certain embodiments, second aperture width 580 is between about ½ inch and about 1 inch.

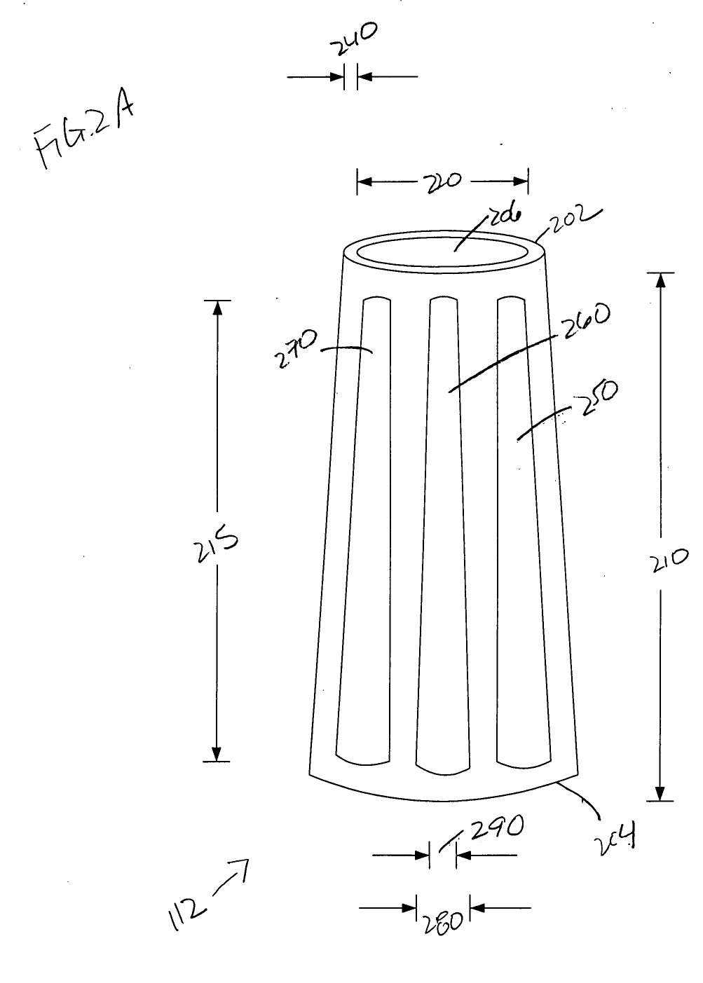

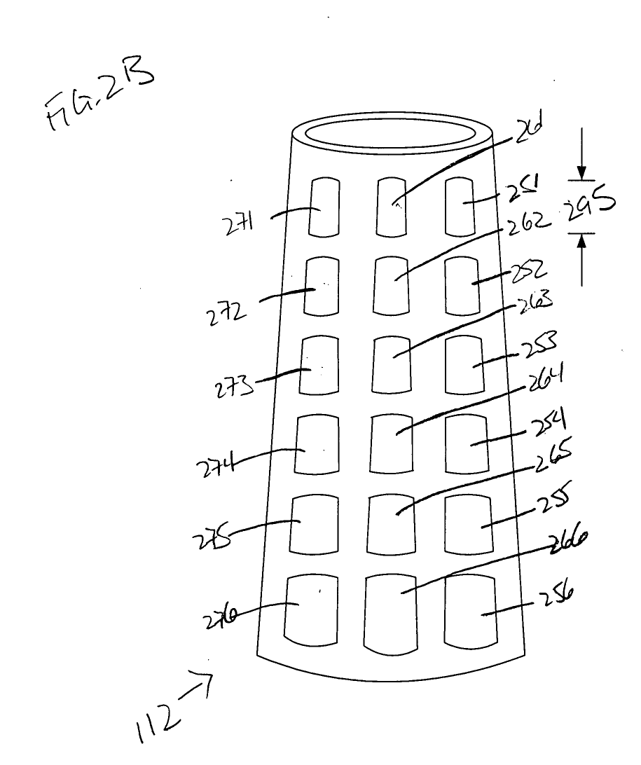

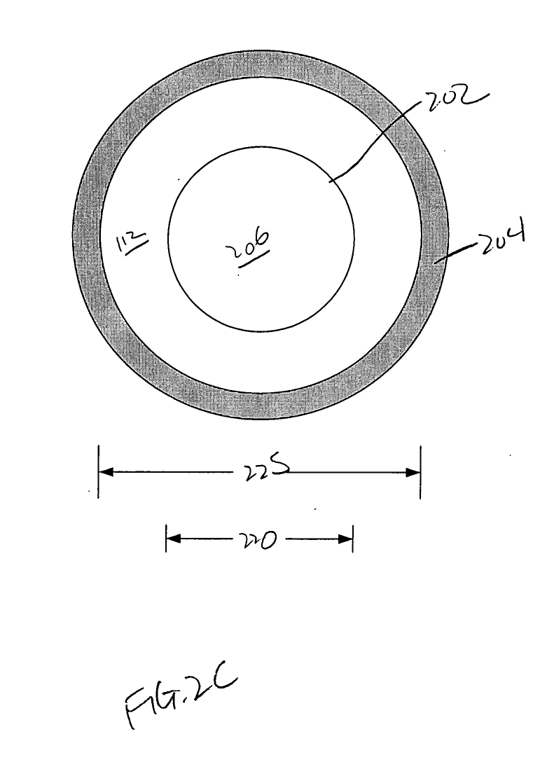

Referring now to FIGS. 2A and 2C, housing 112 comprises a length 210. Length 210 is adjusted based upon the breed and size of the horse. As a general matter, length 210 is determined by measuring the distance between the horse's fetlock to one inch below the knee. As a general matter, length 210 is substantially the same as length 510.

In the illustrated embodiment of FIG. 2A, housing 112 comprises a tubular member comprising a first end 202, a second end 204, and a lumen 206 interconnecting the first end 202 and the second end 204, wherein lumen 206 comprises a first inner diameter 220 at first end 202 and a second inner diameter 225 at the second end 204.

In certain embodiments, first inner diameter 220 is between about 2 inches and about 5 inches. In certain embodiments, the second inner diameter 225 is between about 2 inches and about 5 inches.

The dimensions of first inner diameter 220, second inner diameter 225, and lumen 206, are adjusted such that housing 112 can be removeably disposed around liner 114. More specifically, inner diameter 220 is greater than or equal to outer diameter 530 (FIG. 5A), and inner diameter 225 (FIG. 2C) is greater than or equal to outer diameter 535 (FIG. 5A).

In certain embodiments, housing 112 is formed from a full density synthetic material, such as for example polycarbonate, polyethylene, polypropylene, combinations thereof, and the like. In other embodiments, housing 112 is formed from a rigid cellular material, such as a rigid polyurethane foam, a rigid polystyrene foam, a rigid polyethylene foam, combinations thereof, and the like.

Housing 112 further comprises thickness 240. In certain embodiments, thickness 240 is between about 0.10 inch and about 1 inch. In certain embodiments, housing 112 is about 0.25 inch thick.

In the illustrated embodiment of FIG. 2A, housing 112 is formed to include a plurality of slit-like apertures, such as apertures 250, 260, and 270. Apertures 250, 260, and 270, allow air flow to assist in maintaining a normal body temperature in the covered leg. In the illustrated embodiment of FIG. 2A, apertures 250, 260, and 270, comprise an aperture length 215, and a varying width in the range defined by the first aperture width 290 and the second aperture width 280.

In certain embodiments, aperture length 215 is between about one inch less than length 210. In certain embodiments, first aperture width 290 is between about ⅛ inch and about ½ inch. In certain embodiments, second aperture width 280 is between about ½ inches and about 1 inch.

In the illustrated embodiment of FIG. 2B, housing 112 is formed to include a plurality of window-like apertures, such as apertures 251, 252, 253, 254, 255, 256, 262, 262, 263, 264, 265,266, 271, 272, 273, 274, 275, and 276, wherein each of those apertures is surrounded by portions of housing 112. Apertures 251, 252, 253, 254, 255, 256, 262, 262, 263, 264, 265,266, 271, 272, 273, 274, 275, and 276, allow air flow to assist in maintaining a normal body temperature in the underlying leg portion while protecting that underlying leg from lacerations and/or blunt force trauma.

In the illustrated embodiment of FIG. 2B, apertures 251, 252, 253, 254, 255, 256, 262, 262, 263, 264, 265,266, 271, 272, 273, 274, 275, and 276, comprise aperture length 295 and a varying width in the range defined by the first aperture width 290 (FIG. 2A) and the second aperture width 280 (FIG. 2A). In certain embodiments, aperture length 295 is between about ⅛ inch and about 1 inch.

In certain embodiments, the embodiment of housing 112 formed to comprise a plurality of slit-like apertures, as shown in FIGS. 1A and 2A, is used in combination with liner 114, wherein liner 114 is formed to include a plurality of sit-like apertures, as shown in FIG. 5A. In certain of these embodiments, liner 114 is attached to the inner surface of housing 112 using conventional attachment means, such as adhesive bonding, hook and loop fasteners, and the like. In other embodiments, liner 114 is not attached to housing 112.

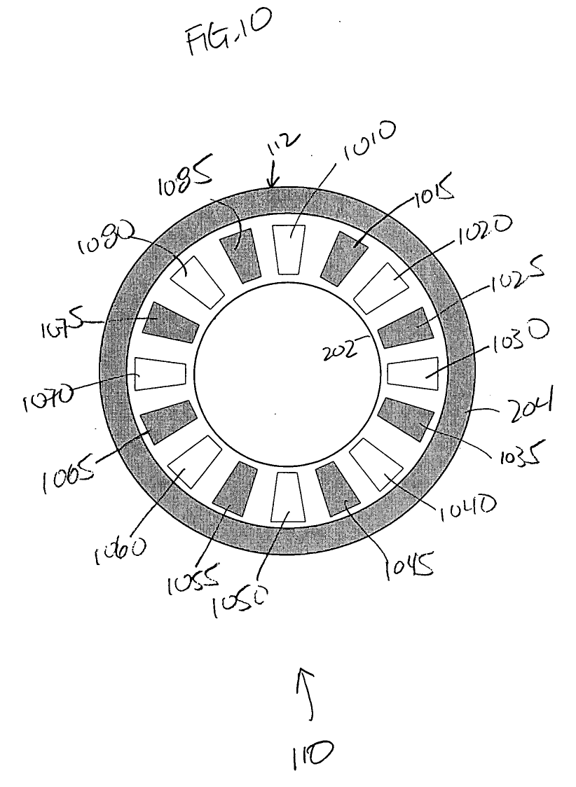

In certain embodiments liner 114 comprises a plurality of separate liner portions that are attached to the inner surface of housing 112 using conventional attachment means. For example in the illustrated embodiment of FIG. 10, leg assembly 110 comprises housing 112 and liner portions 1015, 1025, 1035, 1045, 1055, 1065, 1075, and 1085. Further in the illustrated embodiment of FIG. 10, housing 112 is formed to include apertures 1010, 1020, 1030, 1040, 1050, 1060, 1070, and 1080. Those apertures are formed between housing top 202 and housing bottom 204.

Liner portions 1015, 1025, 1035, 1045, 1055, 1065, 1075, and 1085, are each attached to the inner surface of housing 112, such that each liner portion is disposed between two apertures. Liner portions 1015, 1025, 1035, 1045, 1055, 1065, 1075, and 1085, do not extend completely from housing top 202 to housing bottom 204. Rather, a gap of between one half to one inch separates each liner portion from both the housing top and the housing bottom.

The discontinuity oflinerportions 1015, 1025, 1035, 1045, 1055, 1065, 1075, and 1085 allows dirt and other debris that may pass through one or more of apertures 1010, 1020, 1030, 1040, 1050, 1060, 1070, and 1080, to fall out of the bottom of assembly 100 rather than collect within assembly 110. The discontinuity of liner portions 1015, 1025, 1035, 1045, 1055, 1065, 1075, and 1085 further facilitates air circulation beneath housing 112 thereby cooling the equine leg portion enclosed by leg assembly 110.

In the illustrated embodiment of FIG. 10, apertures 1010, 1020, 1030, 1040, 1050, 1060, 1070, and 1080, comprise slit-like openings as shown in FIGS. 1A and 2A. In other embodiments, leg assembly comprises housing 112 formed to include the plurality of window-like apertures shown in FIGS. 1B and 2B, in combination with a plurality of liner portions attached to interior of that housing 112 as shown in FIG. 10.

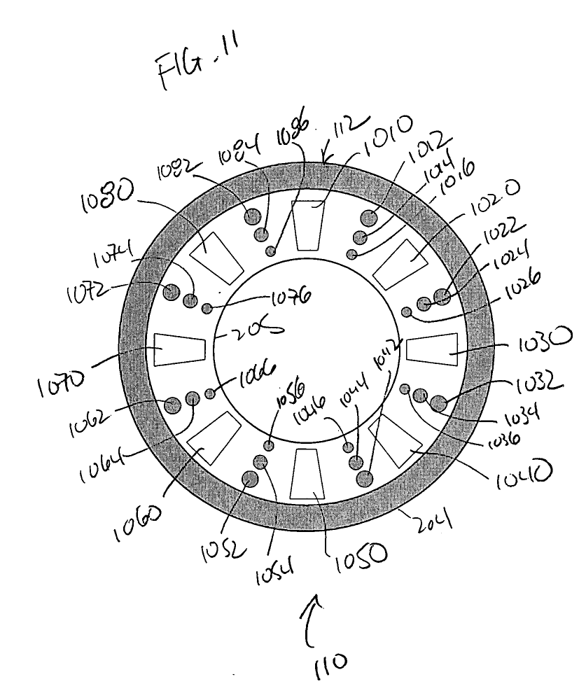

In certain embodiments liner 114 comprises a plurality of separate liner portions that are attached to the inner surface of housing 112 using conventional attachment means. For example in the illustrated embodiment of FIG. 11, leg assembly 110 comprises housing 112 and liner portions 1012, 1014, 1016, 1022, 1024, 1026, 1032, 1034, 1046, 1042, 1044, 1046, 1052, 1054, 1056, 1062, 1064, 1066, 1072, 1074, 1076, 1078, 1082, 1084, and 1086. Further in the illustrated embodiment of FIG. 10, housing 112 is formed to include apertures 1010, 1020, 1030, 1040, 1050, 1060, 1070, and 1080. Those apertures are formed between housing top 202 and housing bottom 204.

Liner portions 1012, 1014, 1016, 1022, 1024, 1026, 1032, 1034, 1046, 1042, 1044, 1046, 1052, 1054, 1056, 1062, 1064, 1066, 1072, 1074, 1076, 1078, 1082, 1084, and 1086, are each attached to the inner surface of housing 112, such that each liner portion is disposed between two apertures.

The discontinuity of liner portions 1012, 1014, 1016, 1022, 1024, 1026, 1032, 1034, 1046, 1042, 1044, 1046, 1052, 1054, 1056, 1062, 1064, 1066, 1072, 1074, 1076, 1078, 1082, 1084, and 1086, allows dirt and other debris that may pass through one or more of apertures 1010, 1020, 1030, 1040, 1050, 1060, 1070, and 1080, to fall out of the bottom of assembly 100 rather than collect within assembly 110. The discontinuity of liner portions 1012, 1014, 1016, 1022, 1024, 1026, 1032, 1034, 1046, 1042, 1044, 1046, 1052, 1054, 1056, 1062, 1064, 1066, 1072, 1074, 1076, 1078, 1082, 1084, and 1086, further facilitates air circulation beneath housing 112 thereby cooling the equine leg portion enclosed by leg assembly 110.

In the illustrated embodiment of FIG. 11, apertures 1010, 1020, 1030, 1040, 1050, 1060, 1070, and 1080, comprise slit-like openings as shown in FIGS. 1A and 2A. In other embodiments, leg assembly comprises housing 112 formed to include the plurality of window-like apertures shown in FIGS. 1B and 2B, in combination with a plurality of liner portions 1012, 1014, 1016, 1022, 1024, 1026, 1032, 1034, 1046, 1042, 1044, 1046, 1052, 1054, 1056, 1062, 1064, 1066, 1072, 1074, 1076, 1078, 1082, 1084, and 1086, attached to interior of that housing 112 as shown in FIG. 11.

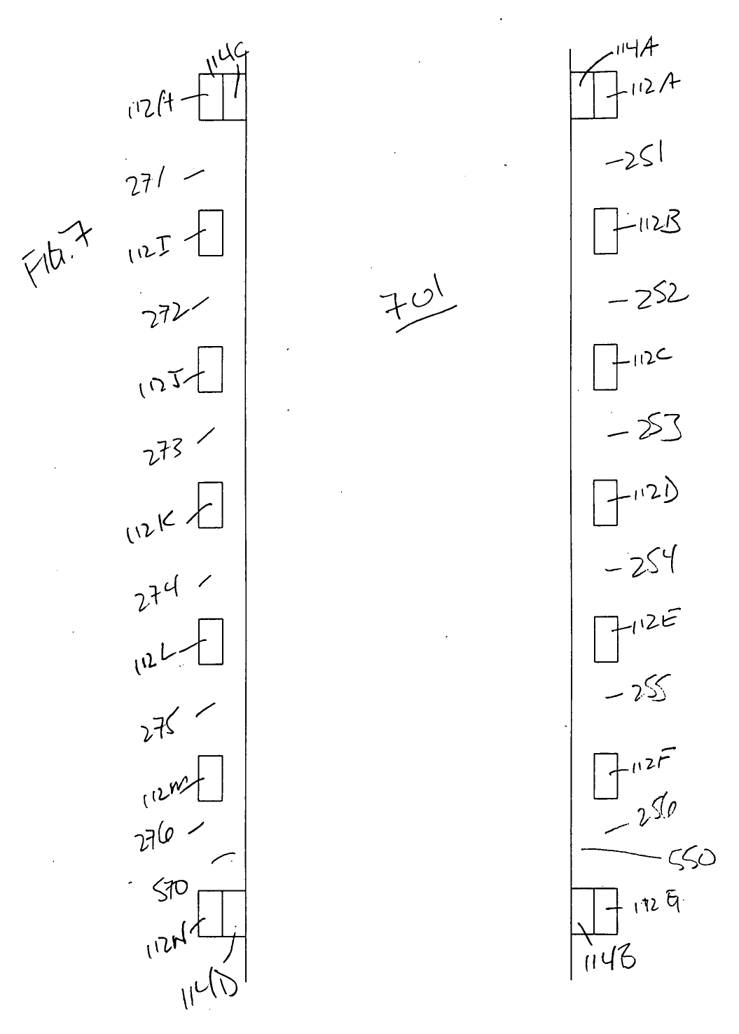

In certain embodiments, the embodiment of housing 112 formed to comprise a plurality of window-like apertures, as shown in FIGS. 1B and 2B, is used in combination with liner 114, wherein liner 114 is formed to include a plurality of sit-like apertures, as shown in FIG. 5A. In certain of these embodiments, liner 114 is attached to the inner surface of housing 112 using conventional attachment means, such as adhesive bonding, hook and loop fasteners, and the like. In other embodiments, liner 114 is not attached to housing 112. Referring now to FIG. 7, equine leg portion 701 is encased with Applicant's liner 114 and housing 112. Liner portions 114A and 114B define the upper and lower boundaries of slit-like aperture 550 (FIG. 5A). Housing portions 112A, 112B, 112C, 112D, 112E, 112F, and 112G, define the boundaries of window-like apertures 251 (FIG. 2B), 252 (FIG. 2B), 253 (FIG. 2B), 254 (FIG. 2B), 255 (FIG. 2B), and 256 (FIG. 2B). FIG. 7 shows that air can freely circulate across the entire portion of the horse's leg exposed by slit-like aperture 550 formed in liner 114 through the plurality of window-like apertures 251, 252, 253, 254, 255, and 256.

Similarly, liner portions 114C and 114D define the upper and lower boundaries of slit-like aperture 570 (FIG. 5A). Housing portions 112H, 112I, 112J, 112K, 112L, 112M, and 112N, define the boundaries of window-like apertures 271 (FIG. 2B), 272 (FIG. 2B), 273 (FIG. 2B), 274 (FIG. 2B), 275 (FIG. 2B), and 276 (FIG. 2B). FIG. 7 shows that air can freely circulate across the entire portion of the horse's leg exposed by slit-like aperture 570 formed in liner 114 through the plurality of window-like apertures 271, 272, 273, 274, 275, and 276.

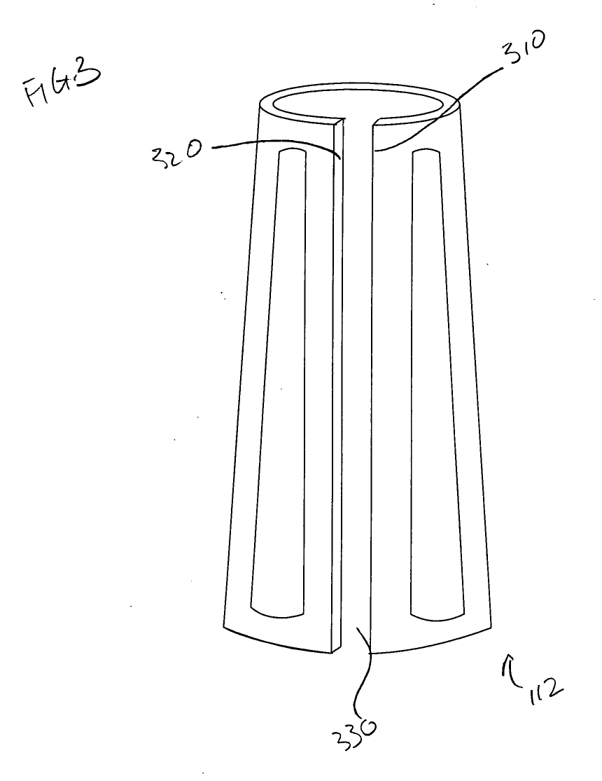

Referring now to FIG. 3, in certain embodiments Applicant's housing 112 comprises a one-piece assembly having a first end 310 and a second end 320, wherein that assembly is formed to include either the plurality of slit-like apertures shown in FIG. 2A or the window-like plurality of apertures shown in FIG. 2B. In order to dispose housing 112 around a horse's lower leg, ends 310 and 320 are manually urged in different directions to open gap 330 sufficiently to place the expanded housing 112 around the target leg. Thereafter, ends 310 and 320 are urged inwardly to enclosed the target lower leg.

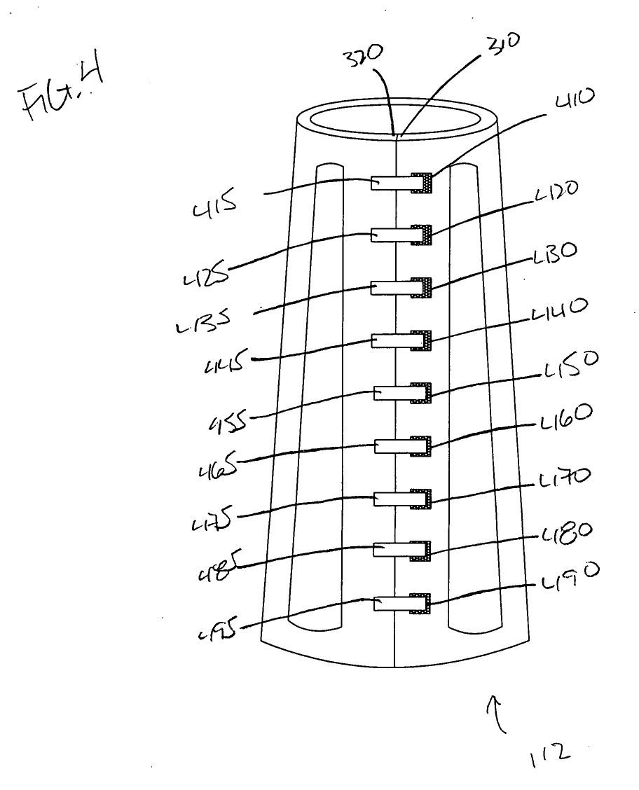

Referring now to FIG. 4, in certain embodiments housing 112 further comprises a plurality of first attachment means and second attachment means to releaseably secure the housing in the closed configuration shown in FIGS. 1A, 1B, 2A, 2B, and 4. In certain embodiments, housing 112 comprises a plurality of first attachment means disposed along end 320, and a plurality of second attachment means disposed along end 310.

In the illustrated embodiment of FIG. 4, housing 112 comprises a plurality of hook and loop fastener assemblies, such as hook and loop fastener assemblies 410/415, 420/425, 430/435, 440/445, 450/455, 460/465, 470/475, 480/485, and 490/495. In the illustrated embodiment of FIG. 4, flexible member 415 comprises a proximal end attached to end 320 of housing 112, a distal end extending outwardly from end 320, and a fastening means, such as fabric comprising a plurality of hook-type fasteners, disposed on the interior surface of that distal end such that the plurality of hook-type fasteners contact, and releaseably attach to, the fastener-receiving means 410. Hook and Loop fastener assemblies 420/425, 430/435, 440/445, 450/455, 460/465, 470/475, 480/485, and 490/495, operate similarly. In other embodiments, fastener assemblies 410/415, 420/425, 430/435, 440/445, 450/455, 460/465, 470/475, 480/485, and 490/495, comprise snaps disposed on the distal ends of flexible members 415, 425, 435, 445, 455, 465, 475, 485, and 495, wherein those snaps are received by, and releaseably attach to, snap-receiving devices 410, 420, 430, 440, 450, 460, 470, 480, and 490.

In other embodiments, housing 112 is formed in two halves, wherein those two halves can be placed around the horse's lower leg, and then joined using a plurality of fastener means disposed on each of the two halves.

In certain embodiments, leg assembly 110 (FIGS. 1A, 1B) comprising housing 112 and liner 114, wherein liner 114 may or may not be attached to housing 112, is not attached to boot assembly 120 comprising boot housing 122 and boot liner 124, wherein boot liner 124 may or may not be attached to boot housing 122. In other embodiments, leg assembly 110 (FIGS. 1A, 1B) comprising housing 112 and liner 114, wherein liner 114 may or may not be attached to housing 112, is releaseably attached to boot assembly 120 comprising boot housing 122 and boot liner 124.

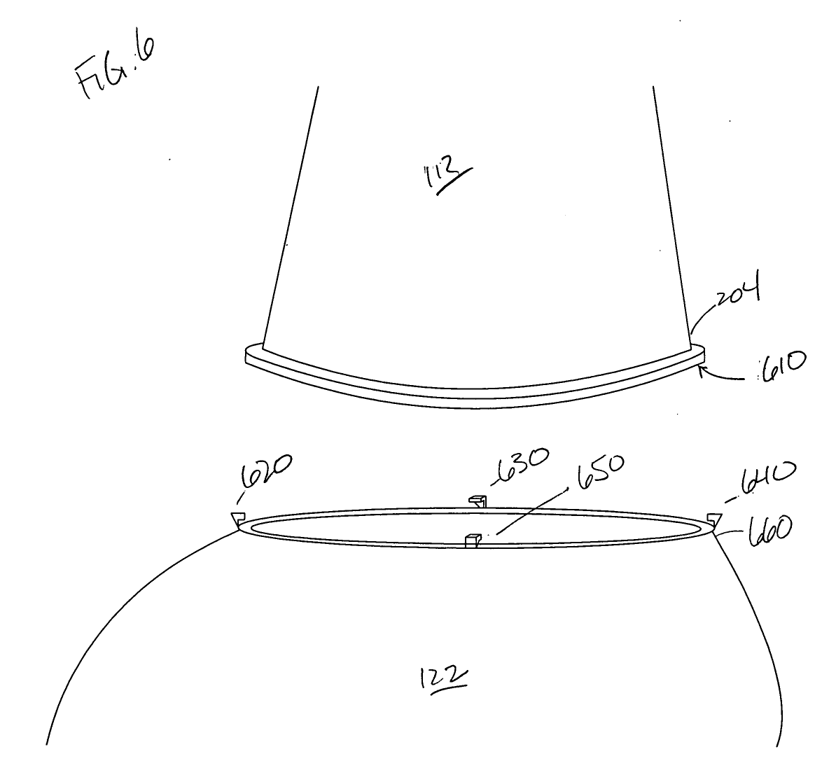

In certain embodiments, housing 112 is releaseably attached to housing 122 using hook and look fasteners. In the illustrated embodiment of FIG. 6, attachment flange 610 is formed on bottom portion 204 (FIG. 2A) of housing 112. Attachment clips 620, 630, 640, and 650, are formed on top portion 660 of boot housing 122. Attachment flange 610 can be releaseably affixed to clips 620, 630, 640, and 650, thereby releaseably attaching housing 112 to housing 122.

While the preferred embodiments of the present invention have been illustrated in detail, it should be apparent that modifications and adaptations to those embodiments may occur to one skilled in the art without departing from the scope of the present invention as set forth in the following claims.

I claim:

1. An equine protective device, comprising:
a first housing removeably disposable around the lower portion of a horse's leg, wherein said first housing is formed to include a plurality of apertures extending therethrough;
a hoof liner removeably disposable around a horse's hoof; and
a second housing removeably disposable around said hoof liner.

2. The device of claim 1, wherein said hoof liner is formed from natural rubber.

3. The device of claim 1, wherein said hoof liner is formed from a flexible foam.

4. The device of claim 1, wherein said first housing is formed from a rigid polymeric material.

5. The device of claim 4, wherein said second housing is formed from a rigid polymeric material.

6. The device of claim 1, further comprising a plurality of leg liner portions, wherein each of said plurality of liner portions is attached to the interior of said first housing between two of said plurality of apertures formed in said first housing.

7. The device of claim 1, wherein said first housing comprises a one-piece assembly comprising:
a first end;
a second end;
a plurality of first attachment means disposed along said first end;
a plurality of second attachment means attached to said second end;
wherein each of said first attachment means can be releaseably attached to a different one of said second attachment means.

8. The device of claim 7, wherein said plurality of first attachment means in combination with said plurality of second attachment means comprises a plurality of hook and loop fasteners.

9. The device of claim 1, wherein said second housing comprises a one-piece assembly comprising:
a first end;
a second end;
a plurality of first attachment means disposed along said first end;
a plurality of second attachment means attached to said second end;
wherein each of said first attachment means can be releaseably attached to a different one of said second attachment means.

10. The device of claim 9, wherein said plurality of first attachment means in combination with said plurality of second attachment means comprises a plurality of hook and loop fasteners.

11. The device of claim 1, wherein said second liner is attached to said second housing.

12. The device of claim 1, wherein said first housing can be releaseably attached to said second housing.
